(19) United States
(12) Patent Application Publication
(10) Pub. No.: US 2025/0010406 A1
(43) Pub. Date: Jan. 9, 2025

(54) DEVICE OF MANAGING WORK PIECE AND METHOD OF MANAGING WORK PIECE

(71) Applicant: NHK SPRING CO., LTD., Yokohama-shi (JP)

(72) Inventor: Osamu IRIUCHIJIMA, Yokohama-shi (JP)

(73) Assignee: NHK SPRING CO., LTD., Yokohama-shi (JP)

(21) Appl. No.: 18/751,445

(22) Filed: Jun. 24, 2024

(30) Foreign Application Priority Data
Jul. 6, 2023 (JP) 2023-111574

(51) Int. Cl. B23K 31/12; B23K 9/095; G06T 7/00

(52) U.S. Cl. CPC B23K 31/125; G06T 7/0004; B23K 9/0953; G06T 2207/30136; G06T 2207/30164

(57) ABSTRACT

A work piece includes a weld. A management device includes a camera, a control unit, and a database. Information on the work piece and a product ID are linked to each other and stored in the database. The weld of the work piece is captured and a nugget pattern thereof is subjected to image processing to obtain pattern data. The pattern data is linked to the product ID and stored in the database. A weld of a work piece with an unknown product ID is captured and a nugget pattern is subjected to image processing to obtain check data. This check data is checked against the existing pattern data, and when the matching data and the existing pattern data match, the product ID linked to the existing pattern data is acquired.

### CROSS-REFERENCE TO RELATED APPLICATIONS

This application is based upon and claims the benefit of priority from prior Japanese Patent Application No. 2023-111574, filed Jul. 6, 2023, the entire contents of which are incorporated herein by reference.

### BACKGROUND OF THE INVENTION

### 1. Field of the Invention

The present invention relates to a device of managing a work piece including a weld and a method of managing such a work piece.

### 2. Description of the Related Art

In order to weld a workpiece made from a plurality of small metal plates such as a suspension for a disk device, laser welding is used in some cases. An example of the laser welding is discussed in JP 2005-95934 A (Patent Literature 1). A suspension for a disc device includes a base plate, a load beam and a flexure disposed along the load beam. The base plate, load beam and flexure are each made from a stainless steel plate. In order to fix the flexure to the load beam, and to fix the load beam to the base plate, spot welding using a laser beam is applied.

For work pieces such as suspensions for disc devices, which are required to be of high quality and manufactured through multiple processes, special management is necessary to maintain the quality and the like. For example, in order to grasp whether or not a work piece is produced in each step under appropriate production conditions, there is a demand of give an ID for identifying a work piece produced, to each work piece. The ID is an abbreviation for identification (identifier). In the production management system described in JP 2023-00687 A (Patent Literature 2), components of electronic device are managed using hash values.

But note that it is difficult in some cases to display an ID of a two-dimensional code or a number or the like on a part of a very small work piece such as a suspension for a disk device. Further, even if an ID can be displayed on a work piece, there is a risk that such s display on the work piece may affect it in some way. According to a production management system that uses hash values, such as the one described in Patent Literature 2, work pieces can be strictly managed. However, the production management using hash values may be difficult to use in some applications because such a system is large and lacks simplicity.

An object of the present invention is to provide a management device which can manage work pieces including welds by laser spot welding or the like and such a management method.

### BRIEF SUMMARY OF THE INVENTION

According to one embodiment, there is provided a management device for managing a work piece including a weld, comprising a camera, an image processing unit, a control unit and a database. The database stores a plurality of product IDs, for example, sequentially, and stores the products ID and information on work piece while linking them respectively with each other. The camera captures the weld of the work piece. The image processing unit obtains pattern data by subjecting a nugget pattern of the weld captured to image processing. The control unit stores the pattern data and the product ID in the database by linking the pattern data and the product ID with each other.

According to this management device of this embodiment, in managing work pieces including welds, featurized pattern data can be obtained based on the image of the nugget patterns of the welds. For work pieces whose product IDs are unknown, the welds of the work pieces are captured to obtain check data according to the nugget pattern. By matching the check data with the existing pattern data, the product ID can be obtained.

The management device of this embodiment may include a camera which captures a weld of a work piece to be traced (work piece whose product ID is unknown), an image processing unit and a control unit for checking. The image processing unit subjects a nugget pattern of the weld captured to image processing to obtain check data according to the nugget pattern. The control unit compares the check data with existing pattern data stored in the database. When the check data matches the existing pattern data, a product ID linked to the existing pattern data is acquired. When the product ID is known, the information on the work piece according to the product ID (detailed information on the work piece) can be obtained.

An example of the workpiece may be a suspension for a disk device, including a plurality of types of welds. The image processing unit may subject the nugget pattern of each of the plurality of types of welds to image processing, to obtain the pattern data according to these nugget patterns.

A plurality of work pieces may be provided in a frame and the frame may have a frame ID. The frame ID and the product ID may be linked with each other and stored in the database. The camera captures, for example, images of front-side nugget portions of the welds. Further, a management device of one embodiment may further comprise an appearance inspection unit which judges whether a shape of appearance the weld is good or no-good.

In a management method for managing a work piece including a weld, according to one embodiment, product information on the workpiece and a product ID are stored in a database while linking them with each other. In the process of obtaining pattern data, the weld of the workpiece is captured. By subjecting nugget patterns of the weld captured to image processing, the pattern data corresponding to the nugget patterns is obtained. Then, the pattern data and the product ID are stored in the database while linking them with each other.

The management method of this embodiment may further include a checking process. In the checking process, a weld of a work piece whose product ID is unknown (work piece to be traced) is captured. By subjecting nugget patterns of the weld captured to image processing, check data according to the nugget patterns is obtained. The check data is compared with the existing pattern data stored in the database. When the check data and the existing pattern data match each other, a product ID linked with the existing pattern data is acquired. Based on the product ID, information on the work piece is obtained.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view of a work piece as one example including a plurality of welds.

FIG. 2 is an enlarged plan view of a first weld of the work piece shown in FIG. 1.

FIG. 3 is a cross-sectional view of the first weld taken along line F3-F3 in FIG. 2.

FIG. 4 is an enlarged plan view of a second weld shown in FIG. 1.

FIG. 5 is an enlarged plan view of a third weld shown in FIG. 1.

FIG. 6 is a front view schematically showing a laser welding device.

FIG. 7 is a cross-sectional view of a portion of the laser welding device shown in FIG. 6 and the first weld.

FIG. 8 is a perspective view schematically showing a management device and a plurality of work pieces according to one embodiment.

FIG. 9 is a flowchart showing an acquisition process for pattern data in a management method according to one embodiment.

FIG. 10 is a plan view showing a first example of the first weld subjected to image process.

FIG. 11 is a plan view showing a second example of the first weld subjected to image process.

FIG. 12 is a plan view showing a third example of the first weld subjected to image process.

FIG. 13 is a flowchart illustrating a matching process of the management method according to one embodiment.

FIG. 14 is a perspective view schematically showing a portion of the management device and a work piece to be traced according to one embodiment.

### DETAILED DESCRIPTION OF THE INVENTION

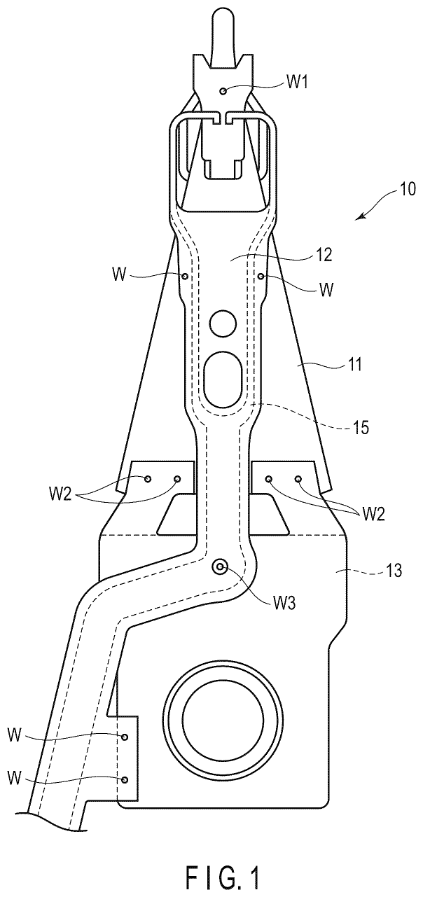

Management devices for work pieces and management methods according to one embodiment will now be described with reference to FIGS. 1 to 14.

FIG. 1 shows a suspension for a disk device as an example of a work piece 10 including a plurality of welds. The work piece 10 shown in FIG. 1 includes a first plate 11, a second plate 12, and a third plate 13. In the case of a suspension for a disk device, the first plate 11 is a load beam, the second plate 12 is a flexure, and the third plate 13 is a base plate.

The first plate 11, the second plate 12, and the third plate 13 are each formed of stainless steel. An example of the stainless steel is austenitic stainless steel such as SUS304. The chemical composition of SUS304 is 0.08 or less of C, 1.00 or less of Si, 2.00 or less of Mn, 8.00 to 10.50 of Ni, 18.00 to 20.00 of Cr and the remainder of Fe.

The first plate (load beam) 11, the second plate (flexure) 12, and the third plate (base plate) 13 have thicknesses different from each other. The thickness of the first plate 11 is greater than that of the second plate 12. The thickness of the first plate 11 is, for example, 100 μm or less. The thickness of the second plate 12 is, for example, 18 μm or less. The thickness of the third plate 13 is greater than that of the first plate 11. The thickness of the third plate 13 is, for example, 200 μm or less. Along the second plate 12, a wiring portion 15 is formed. The wiring portion 15 includes an insulating layer made of an insulating resin such as polyimide and a conductor made of copper.

The first plate 11 and the second plate 12 are secured to each other by a first weld W1. The second plate 12 and the third plate 13 are secured to each other by a second weld W2. The first plate 11, the second plate 12, and the third plate 13 are secured to each other by a third weld W3. In addition to these welds W1, W2, and W3, other welds W are provided as necessary.

The welds W1, W2, and W3 are all formed by laser spot welding. In this specification, the side to which the laser beam is irradiated is referred to as a front side, and the side opposite to that subjected to the laser beam irradiation is referred to as a reverse side. The workpiece (work piece 10) in this embodiment includes the weld W3 where three plates overlap each other. But some workpieces may not have such a three-plate-overlapping weld.

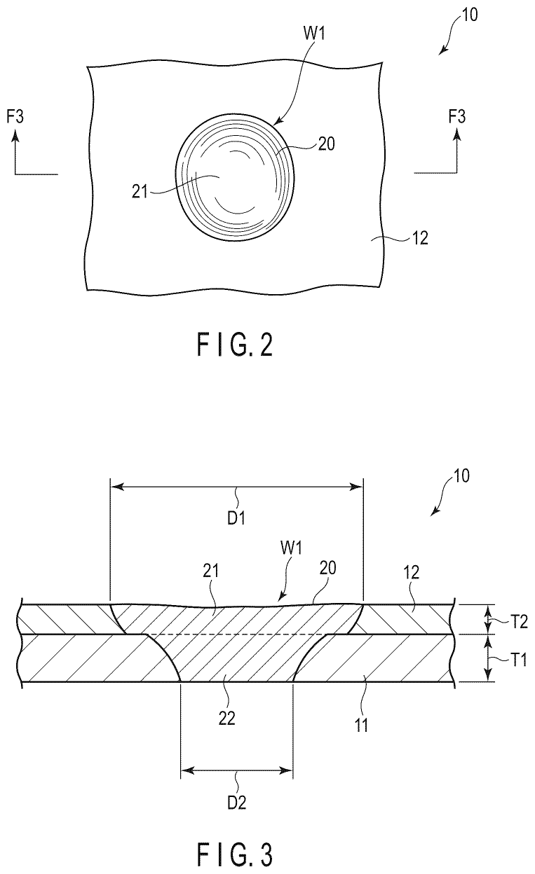

FIG. 2 is a plan view of the first weld W1 as viewed from the front side. As shown in FIG. 2, the first weld W1 is approximately circular in plan view. In other words, it is not necessarily a perfect circle in the strict sense of the word, but is actually a distorted circle, an oval, or any other shape close to a circle. On the surface of the first weld W1, a unique nugget pattern 20 is formed, which was created during welding. The nugget pattern 20 can be observed visually by naked eyes if magnified.

FIG. 3 is a cross-sectional view of the first weld W1 taken along line F3-F3 in FIG. 2. As shown in FIG. 3, the first plate (load beam) 11 having the thickness T1 and the second plate (flexure) 12 having the thickness T2 are welded to each other by the first weld W1. The first weld W1 includes a front-side nugget portion 21 and a reverse-side nugget portion 22. The front-side nugget portion 21 is formed on the second plate 12. The reverse-side nugget portion 22 is formed on the first plate 11.

A diameter D1 of the front-side nugget portion 21 is greater than a diameter D2 of the reverse-side nugget portion 22. The nugget pattern 20 is formed on the front side nugget portion 21. In some workpieces, the reverse-side nugget portion 22 may not penetrate the first plate 11 in the thickness direction. In that case, the diameter D2 of the reverse-side nugget portion 22 is not observed.

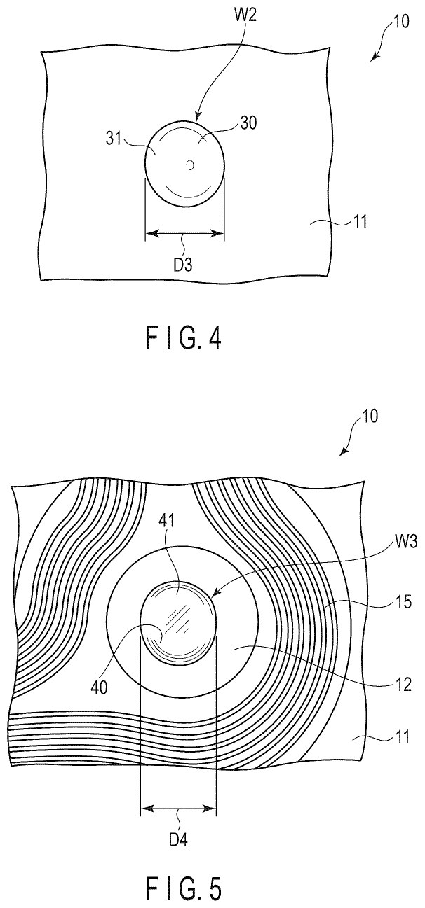

FIG. 4 is a plan view showing the second weld W2. The second weld W2 is formed by laser beam. The laser beam is irradiated onto the site where the first plate 11 and the third plate 13 overlap each other. The laser beam is irradiated from the front side of the first plate 11, for example. A unique nugget pattern 30 created during welding is formed on the front-side nugget portion 31 as shown in FIG. 4.

The first weld W1 and the second weld W2 have welding conditions different from each other. Therefore, a diameter D3 of the second weld W2 (shown in FIG. 4) is different from the diameter D1 of the first weld W1 (shown in FIG. 3). Moreover, the nugget pattern 30 of the second weld W2 is significantly different from the nugget pattern 20 of the first weld W1.

The nugget pattern 20 of the first weld W1 and the nugget pattern 30 of the second weld W2 are different from each other. The reason for this is that the irradiation conditions of the laser beam used for welding are different and the thicknesses of the two plates to be welded are different from each other. Here, the unique nugget pattern 30 may be created according to the coarseness of the surface of the welded plates. The unique nugget pattern 30 may as well be created according to the way the inert gas flowing toward the weld zone hits there, the ambient temperature, and the like.

FIG. 5 is a plan view showing the third weld W3. The third weld W3 is formed by irradiating a laser beam onto the place where the first plate 11, the second plate 12, and the third plate 13 overlap each other. The laser beam is irradiated from the front side of the second plate 12, for example. As shown in FIG. 5, a unique nugget pattern 40 created during welding is formed on the front side nugget portion 41 of the third weld W3.

The welding conditions of the third weld W3 are different from those of the first weld W1 and the second weld W2. Therefore, the diameter D4 of the third weld W3 is different from the diameter D1 of the first weld W1 (shown in FIG. 3) or the diameter D3 of the second weld W2 (shown in FIG. 4). Moreover, the nugget pattern 40 (shown in FIG. 5) of the third weld W3 is significantly different from the nugget pattern 20 of the first weld W1 or the nugget pattern 30 of the second weld W2. The reason for this is, for example, that they have different conditions in laser beam irradiation. Or, the nugget pattern may be different in the third weld W3 due to the overlap of the three plates 11, 12, and 13 and differences in welding conditions such as the manner of the holding jig. The unique nugget pattern 40 may as well be created according to the coarseness of the surface of the welded plates, the way the inert gas flowing toward the weld area hits the weld, the ambient temperature, and the like.

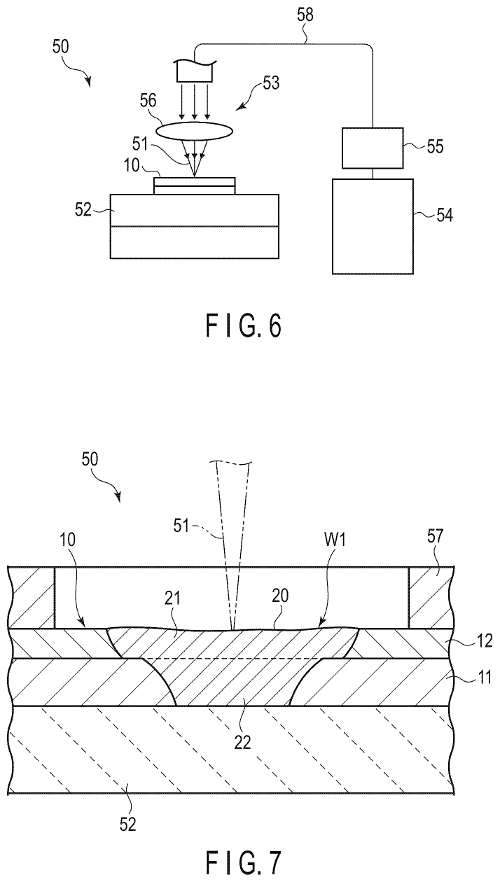

FIG. 6 schematically represents an example of a laser welding apparatus 50. The laser welding apparatus 50 welds a plurality of welds (for example, welds W, W1, W2, W3) by means of a laser beam 51 emitted in pulses. The laser welding apparatus 50 includes a workpiece support 52, a laser irradiation unit 53, a laser beam control unit 54, and a laser oscillator 55, which is the source of the laser beam. The workpiece support 52 supports the work piece 10 to be welded. The laser irradiation unit 53 and the laser oscillator 55 are optically connected to each other by an optical fiber 58.

The laser irradiation unit 53 includes an optical lens system 56 and a galvano-scanner as a scanning mechanism. The galvano-scanner moves the laser beam 51 emitted from the laser irradiation unit 53 toward the welds W, W1, W2, and W3, sequentially. The laser beam control unit 54 includes an electrical configuration to control the laser oscillator 55, software for control, and a memory that stores data for control.

FIG. 7 is a cross-sectional view schematically showing a portion of the laser welding apparatus 50 and the first weld W1. The first plate 11 and the second plate 12 are stacked on the workpiece support 52, for example. With these plates 11 and 12 supported by the holding jig 57, the laser beam 51 is irradiated.

A part of the first plate 11 and a part of the second plate 12 melt by the laser beam 51 melts and solidify. In this manner, the first weld W1 is formed. In the welding process, the first nugget pattern 20 is formed in the first weld W1. FIG. 2 shows an example of the first nugget pattern 20.

By moving the laser beam 51 by the galvano-scanner or the like, the second weld W2 is formed in a manner similar to that of the first weld W1. Further, the third weld W3 is formed. Note here that the order of welding is selected as needed.

As shown in FIG. 4, the second nugget pattern 30 is formed on the surface of the second weld W2. As shown in FIG. 5, the third nugget pattern is formed on the surface of the third weld W3. These nugget patterns 20, 30, and 40 have unique features such as of human fingerprints, depending on the welding conditions and the like.

According to the management device for work pieces and the management method of this embodiment, the nugget patterns of at least parts of the welds W1, W2, and W3 are captured, and subjected to image processing, thus obtaining pattern data. The pattern data is obtained according to, for example, the image data of the first nugget pattern 20, the image data of the second nugget pattern 30, and the image data of the third nugget pattern 40. Or, at least parts of the nugget patterns 20, 30, and 40 are featurized by image processing such as binarization and a predetermined algorithm to obtain the pattern data.

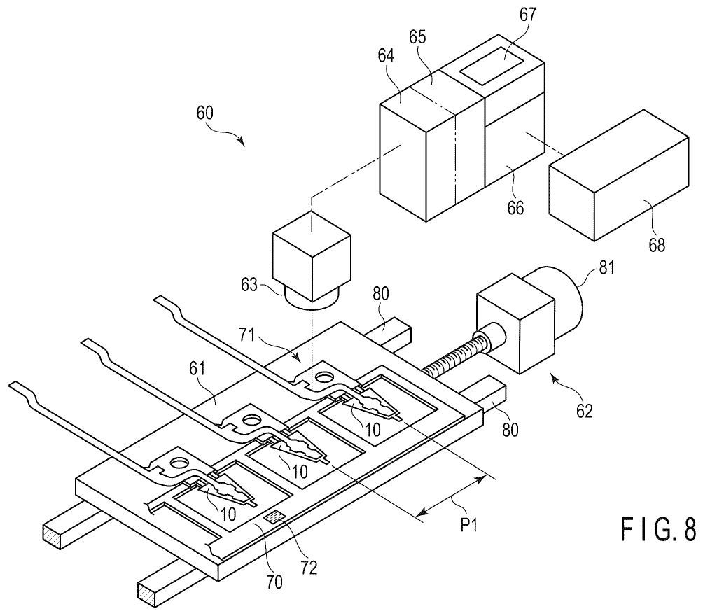

FIG. 8 is a perspective view schematically showing a management device 60 according to one embodiment. An example of the management device 60 includes a workpiece support member 61, a moving mechanism 62, a camera 63, an appearance inspection unit 64, a control unit 66 including an image processing unit 65, a display unit 67, and a database 68. Work pieces 10 is placed on the workpiece support member 61. The plurality of work pieces 10 are connected to a frame 70 at a predetermined pitch P1. The plurality of work pieces 10 and the frame 70 constitute a sheet-like work piece (suspension chain sheet 71).

A frame-side ID, for example, a two-dimensional code or bar code, is provided on the frame 70 of the suspension chain sheet 71. In this specification, the frame-side ID is referred to as a frame ID 72. A plurality of work pieces 10 are provided on the frame 70. Therefore, product IDs for identifying these work pieces 10 are stored in the database 68, for example, as sequential numbers. The database 68 further stores various types of product information related to the work pieces 10 for each product ID. The product information contains, for example, the date, time, location, processing conditions, and material with regard to the production of the work pieces 10. In this manner, when a product ID is known, the product information such as the production history of the work piece 10 and the materials used and the like can be obtained from the database 68.

The moving mechanism 62 includes a guide member 80 and an actuator 81 such as a servo motor. The actuator 81 moves the workpiece support member 61 and the suspension chain sheet 71 along the guide member 80 by a predetermined pitch P1. The camera 63 captures images of the welds W, W1, W2, and W3 of the work pieces 10.

The appearance inspection unit 64 forms part of the management device 60. The appearance inspection unit 64 judges whether or not the shape of appearance of the welds W, W1, W2, and W3 (for example, size, shape, color and the like of the welds) is within the standard range. When it is judged as no good, some kind of problem may have occurred in the production process. Therefore, measures are taken to prohibit the use of the suspension chain sheet 71 containing the no good work piece 10.

The nugget patterns of the welds W1, W2, and W3 are captured by the camera 63. The image processing unit 65 digitizes the captured nugget patterns of the welds W1, W2, W3 into pattern data by image processing such as binarization, a predetermined algorithm and the like. The pattern data is linked to the product ID by the control unit 66 and stored in the database 68.

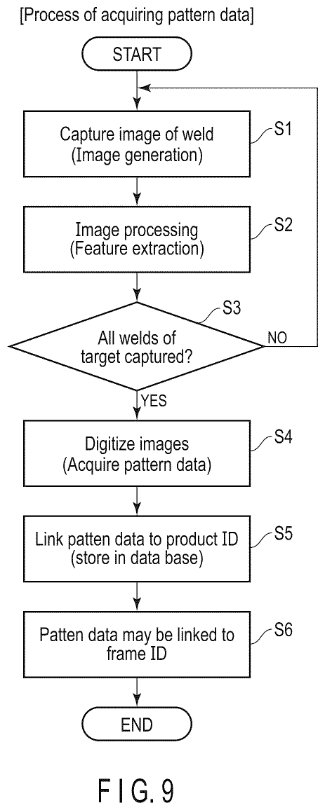

FIG. 9 is a flowchart showing an example of the process of acquiring pattern data. In this process of acquiring pattern data according to the embodiment, the pattern data is acquired based on the image of the weld (its nugget pattern). That is, in step S1 shown in FIG. 9, the weld (for example, the first weld W1) is captured by the camera 63 and an image of the nugget pattern is generated.

In step S2 in FIG. 9, the captured nugget pattern of the weld is processed by the image processing unit 65. The image processing is performed, for example, by binarization, a predetermined algorithm and the like, and thus the nugget pattern of the weld is converted into data. By converting the nugget pattern into data, the features of the weld are extracted. The captured nugget pattern may be displayed on the display 67. Further, the step S2 for processing the image may be carried out after the step S3.

The multiple types of welds W1, W2, and W3 have nugget patterns 20, 30, and 40, respectively, which are significantly different from each other, as shown in FIGS. 2, 4, and 5, respectively. Therefore, when the features of these nugget patterns are combined together, the amount of information used for identification can be increased. That is, the features of the nugget patterns of multiple welds of different types are combined. In this way, the threshold for featurization can be lowered. As the threshold for featurization can be further lowered, the identification of work pieces becomes easier.

The nugget patterns 20 of a plurality of first welds W1 of the same type have features identifiable with each other as of human fingerprints. The nugget patterns 30 of a plurality of second welds W2 of the same type further also have features identifiable with each other. The nugget patterns 40 of a plurality of third welds W3 of the same type also have features identifiable with each other. With this configuration only the nugget patterns of the same type of welds may be extracted.

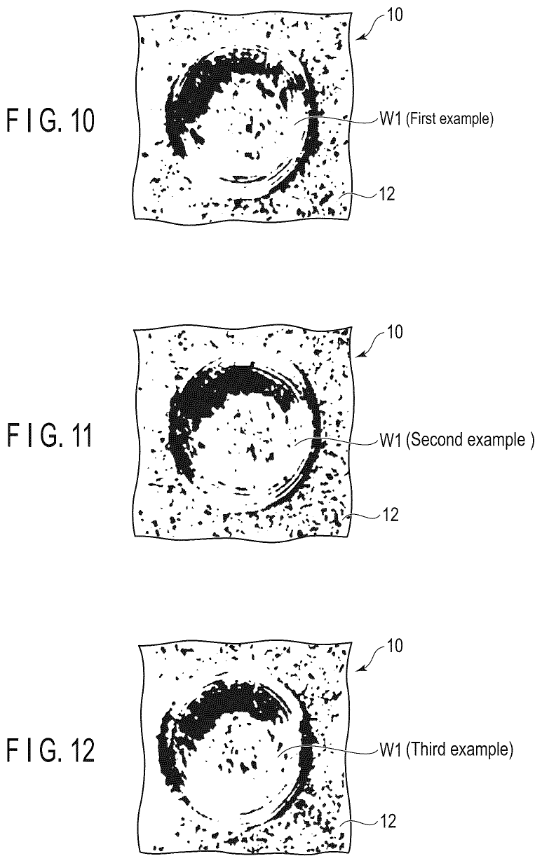

FIG. 10 shows the first example of the image-processed nugget pattern of the first weld W1. FIG. 11 shows the second example of the image-processed nugget pattern of the first weld W1. FIG. 12 shows the third example of the image-processed nugget pattern of the first weld W1. As can be seen from these figures, among a plurality of welds of the same type, they have nugget patterns different from each other.

In step S3 in FIG. 9, it is judged whether all welds to be captured have been captured or not. When all the welds have been captured (“YES” in step S3), the process moves to step S4. When all welds have not been captured (“NO” in step S3), the process returns to step S1 and the next weld is captured. Note that the step S2 may be performed after the step S3.

In step S4 in FIG. 9, the nugget pattern of each of the work pieces is digitized and thus the pattern data corresponding to each nugget pattern is obtained. In step S5, the acquired pattern data is linked to the product ID and stored in the database 68. In this specification, the pattern data linked with the product ID is referred to as existing pattern data.

The pattern data acquired in step S4 may be linked to the frame ID 72 in step S6. By linking the pattern data to the frame ID 72, the information corresponding to the frame ID 72 can be obtained from the database 68.

When there is no need to link the pattern data and the frame ID to each other, the step S6 may be omitted. In another embodiment, the image of the nugget pattern itself captured by the camera 63 is recorded in the database 68 as pattern data. In this manner, the image thus recorded in the database 68 may be then linked to a product ID or frame ID.

The management device 60 in this embodiment includes an appearance inspection unit 64 (shown in FIG. 8) for inspecting the appearances of welds. With this configuration, both the inspection of the appearance of the weld and acquisition of the pattern data can be performed. Note here that the appearance inspection unit 64 may be provided separately from the management device 60.

The work piece 10 whose pattern data has been acquired is separated from the frame 70 (shown in FIG. 8) in a later step. Then, the work piece 10 is incorporated into a predetermined electronic device (for example, a disk device). When the work piece is extremely small, as in the case of a suspension for a disk device, it may be in some cases difficult to display the product ID on the work piece itself. The product ID may be a two-dimensional code or a number.

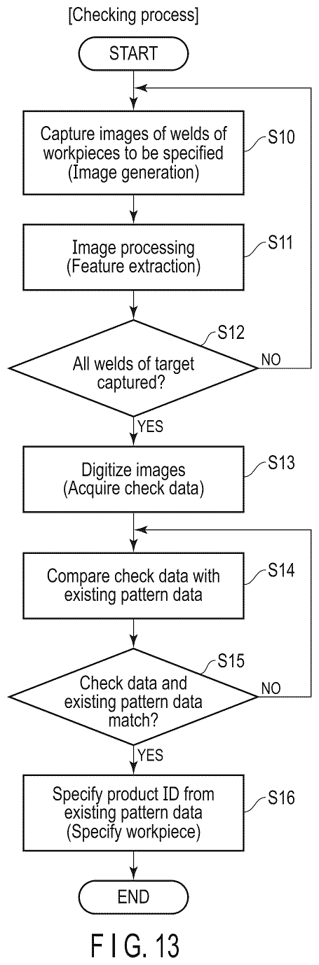

Even when the product ID can be displayed on the work piece itself, there is a risk that the attachment of such a display may affect the work piece in some way. For this reason, it is desirable to avoid displaying the product ID on the work piece itself. However, there are cases where the production history of a work piece whose product ID is unknown, or information on, for example, the materials used therefor need to be known. In this specification and FIG. 13, the work piece with an unknown product ID is referred to as a work piece to be identified or a work piece 10A to be traced. In this specification, “tracing” means to follow up and search the production history back to the past. The work piece 10A to be traced is a work piece for which, for some reason, it is necessary to know its production history, materials used, and the like. An example of the work piece 10A to be traced is one that has been judged as no good due to a defect found in a later step.

In the management method of the embodiment, a matching process, which will be described below, is conducted.

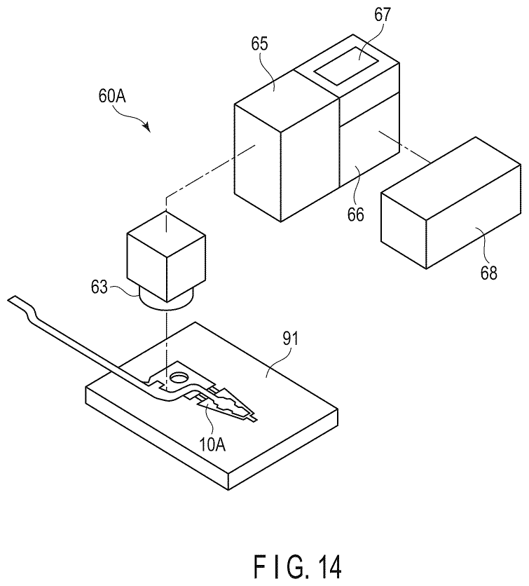

FIG. 13 is a flowchart showing an example of the matching process. FIG. 14 schematically illustrates the management device 60A used in the checking process. A work piece 10A to be traced is placed on a workpiece placement table 91.

As shown in FIG. 14, the management device 60A used in the checking process may be the same as the management device 60 (shown in FIG. 8) used in the pattern data acquisition process. This management device 60A includes a camera 63, an image processing unit 65, a control unit 66, a display unit 67, and a database 68. In another embodiment, the management device 60A used in the matching process may be different from the management device 60 used in the pattern data acquisition process.

In step S10 in FIG. 13, the weld of the work piece 10A to be traced is captured by the camera 63, and an image of the nugget pattern is generated. The image of the nugget pattern is processed by the image processing unit 65 in step S11. The image of the nugget pattern is processed, for example, by image processing such as binarization, which is common to the pattern data acquisition process described above. The captured nugget pattern may be displayed on the display 67. Note that the step S11 of processing the image may be carried out after the step S12.

In step S12, it is judged whether all welds to be captured have been captured. When it is judged that all welds have been captured (“YES” in step S12), the process moves to step S13. When all welds have not been captured (“NO” in step S12), the process returns to step S10 to capture the next weld.

In step S13 shown in FIG. 13, the nugget pattern of the work piece 10A is digitized by a predetermined algorithm to obtain check data. In step S14, the check data obtained in step S13 is compared with the existing pattern data stored in the database 68. For example, the check data and the existing pattern data are compared with respect to each other by the control unit 66.

In step 15 of FIG. 13, when the check data and the existing pattern data match each other (“YES” in step S15), the process moves to step S16. When the check data and the existing pattern data do not match each other (“NO” in step S15), the process returns to step S14 and continues the comparison between the check data and the existing pattern data.

In step S16, based on the existing pattern data that matches the check data, the product ID recorded in the database 68 is specified. When the product ID is linked a frame ID, the frame ID as well is specified. By identifying the product ID and the frame ID recorded in the database 68, information such as the production history of the work piece 10A and the materials used can be known. The obtained information may be displayed on the display 67 or printed out by a printer.

As explained above, according to the management device and management method of this embodiment, it is possible to know the product ID and frame ID of a work piece based on the pattern data obtained from the image of the nugget pattern of the weld thereof. When an ID is known, the information on the work piece can be traced. Therefore, there is no need to provide a special product ID on the work piece itself for management. Since the product ID does not need to be placed on the work piece, it is also possible to avoid the product ID affecting adversely on the work piece.

Note that in implementing the present invention, it is only natural that the specific forms of the camera, image processing unit, display unit, database, control unit and the like, which constitute the management device, can be changed in various ways as needed. Further, the invention can be applied to the management of work pieces other than suspensions for disk devices, as well.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A management device for managing a work piece including a weld, the device comprising:
a database which stores information on the work piece and a product ID linked with the work piece;
a camera which capture the weld of the work piece;
an image processing unit which obtains pattern data by subjecting nugget patterns of the weld captured to image processing; and
a control unit which stores the pattern data and the product ID in the database by linking the pattern data and the product ID with each other.

2. The management device according to claim 1, further comprising:
a camera which captures a weld of a work piece to be traced;
an image processing unit which subjects nugget patterns of the weld captured to obtain check data according to the nugget patterns; and
a control unit which checks the check data against existing pattern data stored in the database and obtains a product ID corresponding to the existing pattern data when the check data matches the existing pattern data.

3. The management device according to claim 1, wherein
the work piece is a suspension for a disk device, including a plurality of types of welds, and
the image processing unit subjects the nugget patterns of each of the plurality of types of welds to image processing, to obtain the pattern data according to these nugget patterns.

4. The management device according to claim 1, further comprising:
a frame on which the plurality of work pieces are provided, comprising a frame ID, wherein
the product ID and the frame ID are linked with each other and stored in the database.

5. The management device according to claim 1, wherein
the camera captures images of front-side nugget portions of the welds.

6. The management device according to claim 1, further comprising:
an appearance inspection unit which judges whether a shape of appearance the weld is good or no-good.

7. A management method for managing a work piece including a weld, the method comprising:
storing information on the work piece and a product ID in a database while linking the information on the work piece and the product ID with each other;
capturing the weld of the work piece;
subjecting nugget patterns of the weld captured to image processing;
obtaining pattern data corresponding to the nugget patterns subjected to the image processing; and
storing the pattern data and the product ID in the database while linking the pattern data and the product ID with each other.

8. The management method according to claim 7, comprising:
capturing a weld of a work piece whose product ID is unknown;
subjecting the nugget pattern of the weld captured to image processing to obtain check data according to the nugget patterns;
checking the check data with existing pattern data stored in the database; and
obtaining, when the check data and the existing pattern data match each other, a product ID linked with the existing pattern data.
